(19) United States
(12) Patent Application Publication
(10) Pub. No.: US 2023/0244542 A1
(43) Pub. Date: Aug. 3, 2023

(54) SYSTEM AND METHOD FOR AUTOMATICALLY IDENTIFYING APPLICATION GROUPS IN CONTAINER DEPLOYMENT ENVIRONMENTS

(71) Applicant: Druva Inc., Sunnyvale, CA (US)

(72) Inventors: Srikiran Gottipati, Vijayawada (IN); Nishith Chitaliya, Amravati (IN); Preethi Srinivasan, Sunnyvale, CA (US); Stephen Manley, Livermore, CA (US)

(21) Appl. No.: 17/590,966

(22) Filed: Feb. 2, 2022

(51) Int. Cl. G06F 9/50

(52) U.S. Cl. CPC G06F 9/5077

(57) ABSTRACT

A system for automatically identifying an application group in a container deployment environment is presented. The system includes a reference detection module configured to detect and store one or more reference paths corresponding to each resource type of a plurality of resources in the container deployment environment. The system further includes a resource classification module configured to assign a resource class to each resource type of the plurality of resources. The system moreover includes a resource grouping module configured to group the plurality of resources into one or more resource groups, for each namespace, based on the corresponding resource type, resource class, and one or more reference paths. The system furthermore includes an application group definition module configured to generate an application group definition based on the one or more resource groups. A related method is also presented.

### BACKGROUND

Embodiments of the present invention generally relate to the identification of application groups in container deployment environments, and more particularly to automatic identification of application groups in a Kubernetes environment.

An application running within a Kubernetes environment consists of native Kubernetes resources (e.g., service accounts, stateful sets, persistent volumes, secrets, etc.) and potentially custom resources that are defined specifically for that application. Identifying what resources make the Kubernetes application may be important for application discovery, backup, avoiding restore failures, disaster recovery, compliance management, granular recreation, and the like. Therefore, it becomes incumbent on part of the application admins to accurately specify an application definition such that all application's resources are captured accurately.

However, accurately specifying an application definition may be challenging as application admins may not be aware of all the resources that are part of an application, or the resources may be inaccurately or incompletely labeled. Further, Kubernetes applications may include custom resources created at runtime that cannot be specified statically and may require labels to be propagated at runtime. Moreover, it may be difficult to determine the accuracy of application definitions and missing resources may result in errors during application retrieval.

Typical Kubernetes protection vendor solutions do not identify application boundaries and resort to recreating entire namespaces. Such an approach works in scenarios where only one application is deployed per namespace and the namespace boundary is also the application boundary. However, when more than one application is deployed per namespace, these solutions lose the ability to discover, protect, manage, and restore each application in isolation.

Some Kubernetes protection solutions create application-aware backups but require their application administrators to accurately label all the resources that constitute the application. The disadvantage with such solutions is that it passes the task of identifying all the resources to the customer, adding more work to their administrators. Additionally, it can be error-prone as it is easy to miss resources that constitute the application. Some solutions accept Helm releases to identify the application resources, but not all applications have Helm packages while some customers choose to install without using Helm. Also, Helm packages don't help detect resources created by the Application itself. In addition, creating a Helm chart installation for the Kubernetes application just to enable application-aware backups is unrealistic. Moreover, as noted earlier, even if the Kubernetes protection vendors use static lists of resources to backup, it might not account for Kubernetes resources created at post-installation runtime.

Thus, there is a need for systems and methods that accurately define application definitions at runtime for Kubernetes protection.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for automatically identifying an application group in a container deployment environment is presented. The system includes a reference detection module configured to detect and store one or more reference paths corresponding to each resource type of a plurality of resources in the container deployment environment. The system further includes a resource classification module configured to assign a resource class to each resource type of the plurality of resources. The system moreover includes a resource grouping module configured to group the plurality of resources into one or more resource groups, for each namespace, based on the corresponding resource type, resource class, and one or more reference paths. The system furthermore includes an application group definition module configured to generate an application group definition based on the one or more resource groups.

According to another example embodiment, a system for automatically identifying an application group in a container deployment environment is presented. The system includes a memory storing one or more processor-executable routines; and a processor communicatively coupled to the memory. The processor is configured to execute the one or more processor-executable routines to detect and store one or more reference paths corresponding to each resource type of a plurality of resources in the container deployment environment, assign a resource class to each resource type of the plurality of resources, group the plurality of resources into one or more resource groups for each namespace, based on the corresponding resource type, resource class, and one or more reference path, and generate an application group definition based on the one or more resource groups.

According to another example embodiment, a method for automatically identifying an application group in a container deployment environment is presented. The method includes detecting and storing one or more reference paths corresponding to each resource type of a plurality of resources in the container deployment environment. The method further includes assigning a resource class to each resource type of the plurality of resources and grouping the plurality of resources into one or more resource groups for each namespace, based on the corresponding resource type, resource class, and one or more reference paths. The method furthermore includes generating an application group definition based on the one or more resource groups.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example system for automatically identifying application groups in container deployment environments, according to some aspects of the present description,

FIG. 2 is an example of a TypedReference, according to some aspects of the present description,

FIG. 3 is an example of ObjectReference, according to some aspects of the present description,

FIG. 4 is an example of the references in the persistent volume claim resource, according to some aspects of the present description,

FIG. 5 illustrates an example of a plurality of resources classified into a resource class, according to some aspects of the present description,

FIG. 6 shows an example grouping algorithm, according to some aspects of the present description,

FIG. 7 illustrates an example of class-based grouping of a plurality of resources classified into a resource class, according to some aspects of the present description,

FIG. 8 is a block diagram illustrating an example system for automatically identifying application groups in container deployment environments, according to some aspects of the present description,

FIG. 9 is a flow chart illustrating a method for automatically identifying application groups in container deployment environments, according to some aspects of the present description, and

FIG. 10 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for automatically identifying an application group in a container deployment environment. Non-limiting examples of container deployment environments include Docker Swarm, Kubernetes, Openshift, Hashicorp, Rancher, Mesos, cloud container environments in AWS, Azure, Google Cloud, and the like. For the purpose of this description, the following embodiments are described with respect to a Kubernetes-based container deployment environment. However, it must be understood that embodiments described herein can be implemented in any container deployment environment.

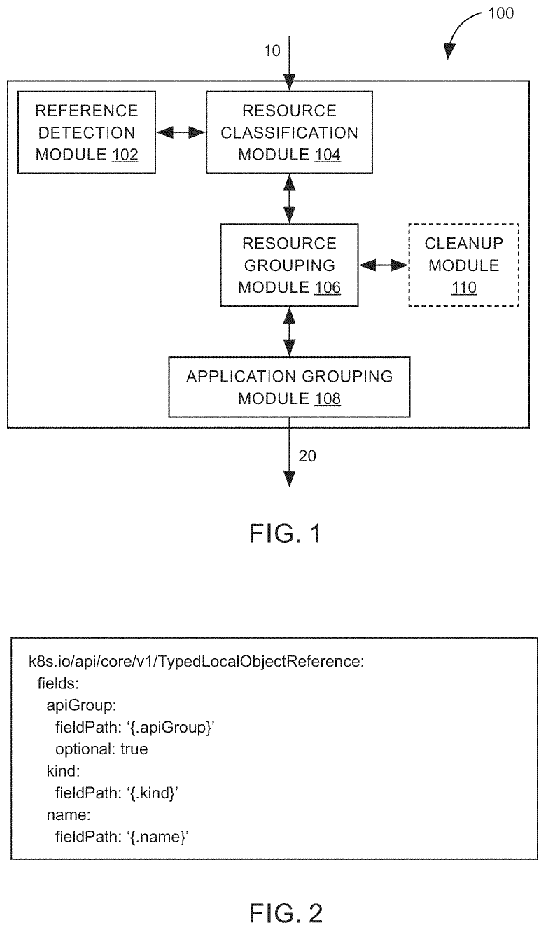

FIG. 1 illustrates an example system 100 for automatically identifying an application group in a container deployment environment, for example, a Kubernetes environment. The system includes a reference detection module 102, a resource classification module 104, a resource grouping module 106, and an application group definition module 108. Each of these modules is described in detail below.

As mentioned earlier, applications running on a Kubernetes cluster consist of a set of Kubernetes resources created at installation time or post-installation runtime. The resources created at installation may include native Kubernetes resources (e.g., service accounts, stateful sets, persistent volume, secrets, and the like), and potentially custom resources that are defined specifically for a particular application.

Each resource within the Kubernetes environment is characterized by resource type. Non-limiting examples of resource types in a Kubernetes environment include pods, persistent volumes, persistent volume claims, secrets, services, configmaps, statefulsets, deployments, and the like. The resource types are each characterized by a resource definition. Each resource type is further characterized by a reference path which may include one or more references that point/refer to another resource within the Kubernetes environment. The references are further characterized by reference types.

Thus, Kubernetes resources reference other resources using reference types. Reference types use one or more of the resource fields or selector fields to reference other resources. Non-limiting examples of fields used to identify a Kubernetes resource include API version, Resource Kind, Namespace, Name, Unique Identifier (UID), Group version, and the Group Kind.

Examples of reference types include direct references or label selectors. Direct references reference a single resource using one or more of the resource identity fields. The information present in these references may, in some cases, be insufficient to uniquely identify the referenced resource. But that is only because, the resource's controller is aware of the reference field and has the missing information, required to uniquely identify the referenced resource, in its logic.

Non-limiting examples of direct references may further include Typed References, UntypedReferences, NamedReferences, and owner fields. TypedReferenecs include Reference types with well-defined (golang struct) types within the Kubernetes frameworks. Non-limiting example of TypedReferences include LocalObjectReference, TypedLocalObjectReference, ObjectReference, SecretReference, CrossVersionObjectReference, Subject, RoleRef and the like.

UntypedReferences are references defined loosely as a collection of field paths, label keys, and/or annotation keys. For example, secret associated with a ServiceAccount has the following annotations which, together, make up the Untyped

Reference that references the ServiceAccount:
kubernetes.io/service-account.name
kubernetes.io/service-account.uid

NamedReferencees are a special kind of UntypedReference which is a single field of type string that can be used to reference another resource just by its name. OwnerReferences are part of every resource's metadata and can contain references to its owner resource and any other resources that participate in its management. It's also used to garbage collect resources upon deletion of all OwnerReference resources.

Owner resources use LabelSelector fields as a way to define sets of owned resources that they own and/or manage. In most cases, each owned resource has an OwnerReference entry that references back to the owner resource. For example, a StatefulSet resource identifies the set of all its Pod resources with a label selector, and each Pod resource from that set has an OwnerReference that back references the StatefulSet resource. LabelSelectors may further be classified into StringLabelSelector, TypedLabelSelector, and ObjectLabelSelector.

StringLabelSelector is a selector of type string that accepts SQL style filters. For example, environment=production, tier=frontend. TypedLabelSelectors are selectors with well-defined Kubernetes native types. For example, metav1.LabelSelector defined in k8s.io/apimachinery. ObjectLabelSelector is a selector with the generic object type—map[string]string.

Referring again to FIG. 1, the reference detection module 102 is configured to detect and store one or more reference paths corresponding to each resource type of a plurality of resources in the container deployment environment. The reference detection module 102 is configured to automatically detect the one or more reference paths corresponding to each resource type at start-up or when a new resource definition (i.e., custom resource definition (CRD)) is identified.

In some embodiments, the reference detection module 102 is configured to detect the one or more reference paths corresponding to each resource type by scanning binary schema. In some embodiments, the reference detection module 102 is configured to detect the one or more reference paths corresponding to each resource type by scanning all registered resource schemas using reflection techniques. In such embodiments, the reference detection module 102 is configured to auto-discover reference and selector fields present in all registered Kubernetes native and custom resource types by parsing their binary schemas using type reflection

In some other embodiments, for example, when binary schemas are not registered with the runtime client, the reference detection module 102 is configured to detect the one or more reference paths corresponding to each resource type by scanning text schemas for one or more resource types in the container deployment environment. Non-limiting examples of text schemas include open API schemas, postman schemas, JSON API schemas, and the like. In such embodiments, the reference detection module 102 is configured to use reference signatures for the identification of references during a scan of the reference schemas. The reference signatures may be added to the configuration manually.

In an example embodiment, at startup or when notified of new resource definitions, the reference detection module 102 is configured to identify fields with type as one of the known reference types. The reference detection module 102 is further configured to load all resource type definitions registered with the Kubernetes API server and all known reference type signatures specified in the configuration. The reference detection module 102 is further configured to scan each resource type schema for references using the reference type signatures. The reference detection module 102 is further configured to capture and persist the list of field paths along with their corresponding reference types for each resource type.

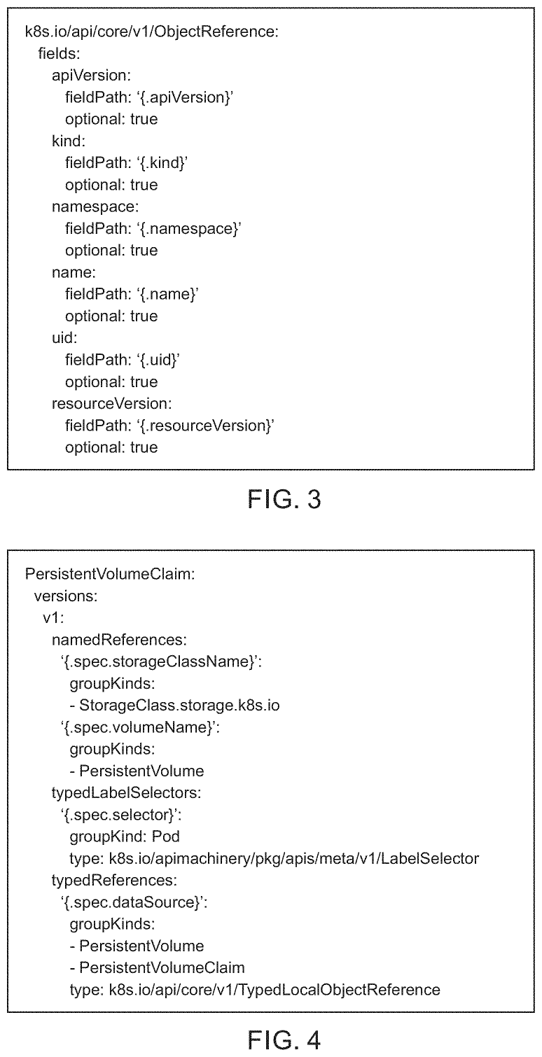

FIG. 2 is an example of a TypedReference called TypedLocalObjectReference defined in the package k8s.io/api/core/v1. TypedLocalObjectReference is a well-defined reference with 3 fields apiGroup, kind, and name where the apiGroup field is optional and the others are mandatory. FIG. 3 is an example of ObjectReference having 6 fields—apiVersion, kind, namespace, name, uid, and resourceVersion.

FIG. 4 is an example of the references in the persistent volume claim resource. The persistent volume claim resource has 1 TypedReference of type TypedLocalObjectReference at path spec.dataSource which can reference a persistent volume or another persistent volume claim

Referring back to FIG. 1, the reference detection module 102 is further configured to augment auto-detection of the one or more references paths corresponding to a resource type based on manual updates. In such embodiments, the reference detection module 102 is configured to capture through auto-discovery previously unseen reference types. Further, the reference detection module 102 is configured to specify the expected types of resources that a given reference field can reference.

The resource classification module 104 is configured to assign a resource class to each resource type of the plurality of resources in the Kubernetes environment. The resource class includes a core class, a system class, a shared class, or a private class. In some embodiments, the resource classification module is configured to assign a resource class based on the following rules.

All known Kubernetes native and custom resource types are initially tagged with a resource class. All resources of a given resource type belong to the same resource class as their resource types. Any untagged resource type, such as newly defined custom resource types, is tagged with the private resource class by default. Resources of some resource types may have been created for different purposes and can therefore be classified differently from its resource type. For example, all service account resources in all namespaces belong to the private class, except for the service account named “default” which is created by default in each namespace and belongs to the system class.

The system class of resources does not belong to any resource group. They include resources created by the system to support the applications. For example, resources related to networking like Endpoints, EndpointSlices, etc. The system class of resources also includes resources created by the admin to support applications. For example, a FluentD DaemonSet setup to upload logs of all applications to a central location. The system class of resources can also include cluster scoped resources, like storage class, which can be used and referenced by applications across all namespaces within the cluster.

The shared class of resources may belong to more than one resource group. They cannot seed resource groups by themselves. Moreover, a group of shared class of resources by themselves or in combination with a group of private class resources cannot form a resource group. Some Kubernetes resources like secrets used for specific purposes, say as ImagePullSecrets can also be marked as shared class resources.

The private class of resources can belong to at most one resource group. If two resource groups contain the same private class resource, they must be fused to form a single resource group. The private class of resources cannot seed resource groups by themselves. A group of private class resources by themselves or in combination with a group of system class resources cannot form a resource group. Kubernetes native core resources like pods, secrets, serviceaccounts, configmaps are some examples of private class of resources.

The core class of resources belongs to at least one resource group. If two resource groups contain the same core class resource, they must be combined to form a single resource group. The core class of resources can seed resource groups and every resource group must have at least one core class resource. Kubernetes native core resources like jobs, statefulsets, replicasets, deployments are some examples of this resource class.

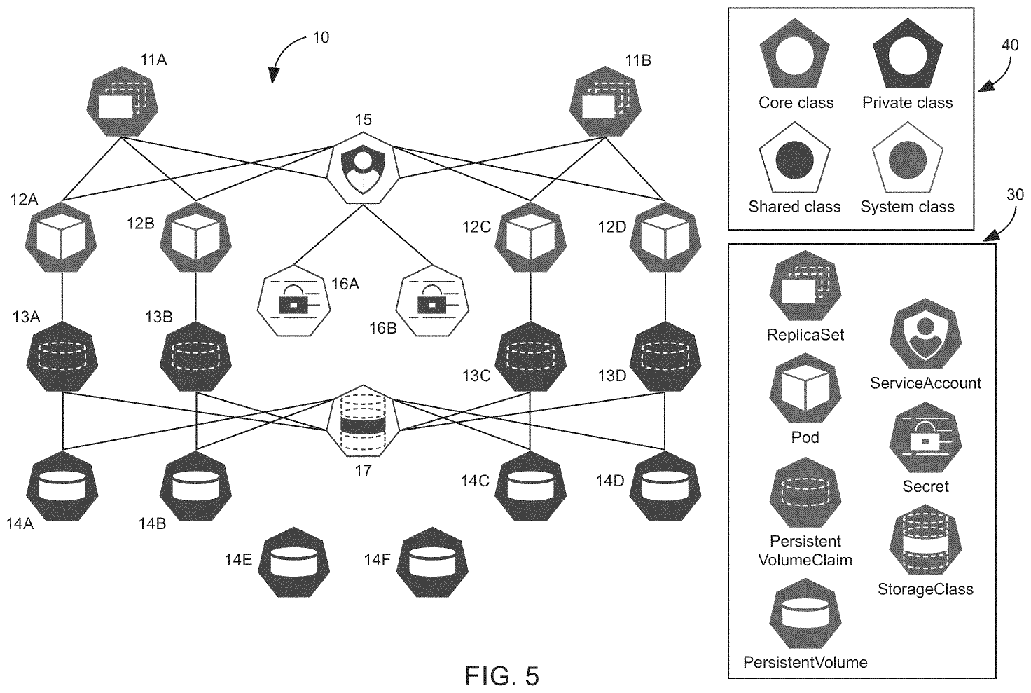

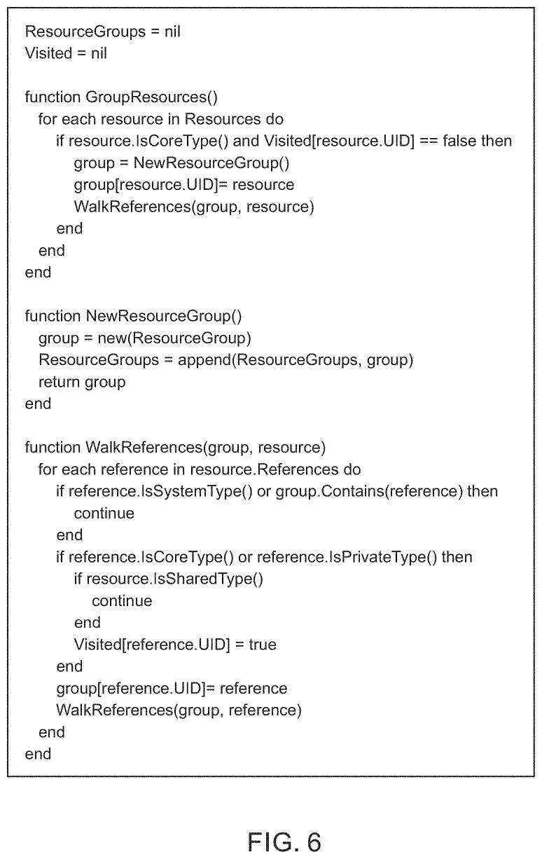

FIG. 5 illustrates an example of a plurality of resources 10 classified into a resource class according to embodiments of the present description. A shown in FIG. 6, the plurality of resources include replica sets 11A-11B, pods 12A-12D, persistent volume claims 13A-13D, persistent volume 14A-14F, service account 15, secrets 16A-16B, and storage 17. FIG. 5 further illustrates an index 30 for each resource and a classification index 40 for each resource. For example, the replica sets 11A and 11B are each classified as a core class. Similarly, the pods 12A-12D are also classified as a core class. The persistent volume claims 13A-13D and persistent volumes 14A-14F are classified as a private class. The service account 15, secrets 16A-16B, and storage are classified as a shared class. Thus, each resource of the plurality of resources is assigned a class based on the resource type.

Referring again to FIG. 1, the resource grouping module 106 is configured to group the plurality of resources 10 into one or more resource groups, for each namespace, based on the corresponding resource type, resource class, and one or more reference paths.

The resource grouping module 106 is configured to group one or more resources of the plurality of resources 10 into one or more resource groups based on class-based rules. The resource grouping module 106 is configured to treat the resources and their references as an undirected graph with resources as vertices and references as undirected edges. The resources are grouped into resource groups while adhering to the following invariants.

A resource group can contain only core class, private class, and shared class of resources. A resource group must have at least one core class resource to be a valid resource group. For every shared class resource within a resource group, there must be a core class resource within the resource group and a path that connects the two resources. For every private class resource of a resource group, there must be a core class resource within the resource group and a path that connects the two resources without passing through a shared class resource. For two core class resources to belong to the same resource group, there must be a path that connects the two resources without passing through a shared class resource. A resource cannot belong to more than one resource group unless it's a shared class resource. FIG. 6 shows an example grouping algorithm in accordance with embodiments of the present description.

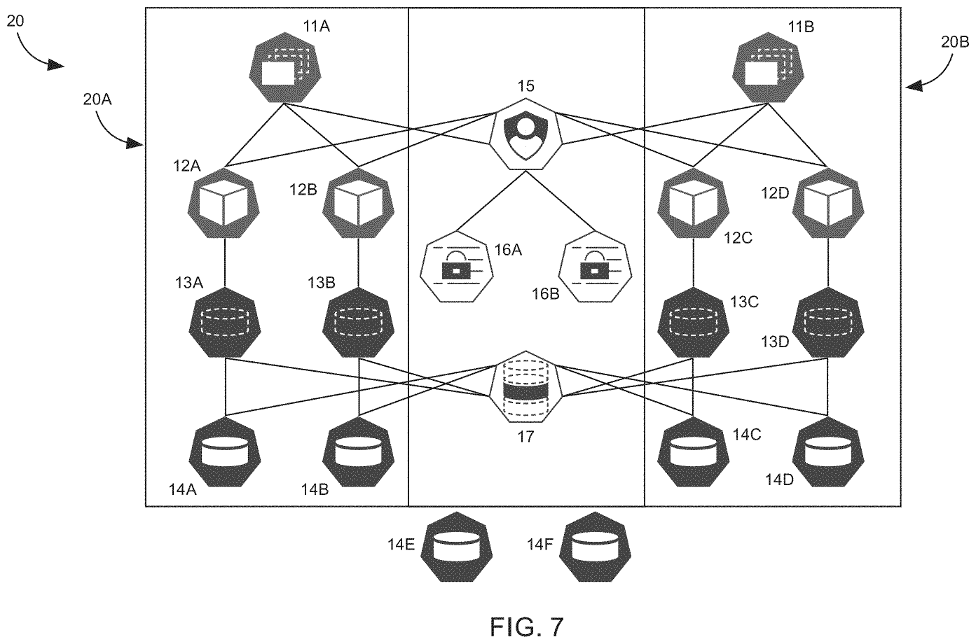

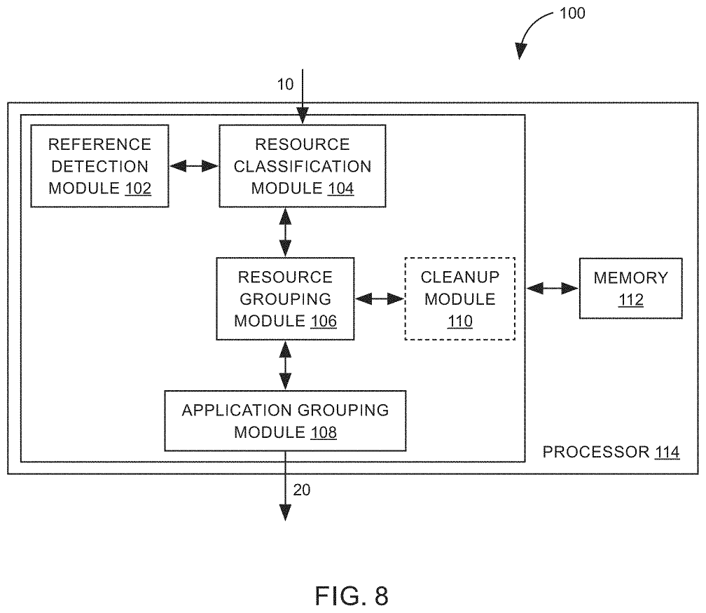

FIG. 7 illustrates an example of class-based grouping of a plurality of resources 10 classified into a resource class as described earlier in the context of FIG. 6. As shown in FIG. 7, the plurality of resources 11A, 12A-12B, 13A-13B, 14A-14B, 15, 16A, and 17 are grouped into a resource group 20A. Similarly, the plurality of resources 11B, 12C-12D, 13C-13D, 14C-14D, 15, 16B, and 17 are grouped into a resource group 20B. As noted earlier, each resource group includes at least one core class of resources, e.g., stateful set and pods. The stateful sets seed an application group in the illustrated example. There is a path that connects the stateful set with the pods without passing through a shared class resource. Further, each resource group of FIG. 8 also includes a private class of resources such as persistent volume claims and persistent volumes. There is a path that connects the persistent volume claims and persistent volumes with a core class of resources (e.g., a pod) without passing through a shared class resource. Furthermore, each resource group also include a shared class of resources such as service account and secrets, which are connected to a core class of resources such as the replica set or the pods. The shared class of resources are part of both the application groups. Thus, the plurality of resources 10 are grouped or partitioned into two independent resource groups 20A and 20B,

Referring again to FIG. 1, in some embodiments, the system 100 may further include a clean-up module 107 configured to delete one or more resources of the plurality of resources if there is no group assigned to the one or more resources by the resource grouping module. For example, in the example illustrated in FIG. 8, the persistent volumes 14E and 14F classified as a private class are not assigned to a particular resource group as they don't have a path to a core class, and may therefore be deleted by the clean-up module 107.

With continued reference to FIG. 1, the application group definition module 108 is configured to generate an application group definition based on the one or more resource groups. The application group definition may be used to recreate an application based on the one or more resource groups. The application recreation may include use cases such as application discovery, application backup, application restore, disaster recovery, compliance management, granular recreation, and the like. In some embodiments, the application definition module 108 is further configured to periodically update the definition of application groups in the Kubernetes clusters.

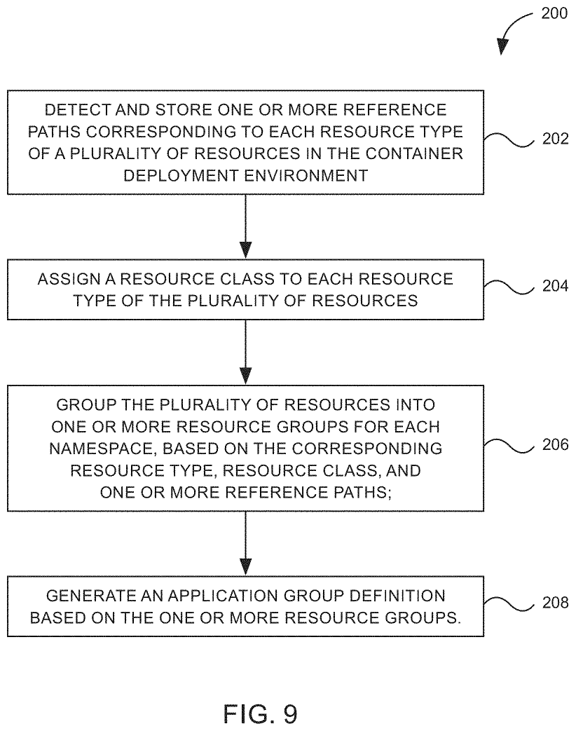

Referring now to FIG. 8, a system 100 for automatically identifying an application group in a container deployment environment, for example, a Kubernetes environment is presented. The system 100 includes a memory 112 storing one or more processor-executable routines, and a processor 114. The processor 114 includes a reference detection module 102, a resource classification module 104, a resource grouping module 106, and an application group definition module 108. Each of these modules is described in detail earlier. The processor 114 is further configured to execute the processor-executable routines to perform the steps illustrated in the flow-chart of FIG. 9.

FIG. 9 is a flowchart illustrating a method 200 for automatically identifying an application group in a container deployment environment, for example, a Kubernetes environment. The method 200 may be implemented using the application identification system 100 of FIGS. 1 and 8 according to some aspects of the present description. Each step of the method 200 is described in detail below.

The method 200 includes, at block 202, detecting and storing one or more reference paths corresponding to each resource type of a plurality of resources in the container deployment environment. The method 200 includes, at block 202, automatically detecting the one or more reference paths corresponding to each resource type at start-up or when a new resource definition (i.e., custom resource definition (CRD)) is identified.

In some embodiments, the method 200 includes, at block 202, detecting the one or more reference paths corresponding to each resource type by scanning binary schema. In some embodiments, the method 200 includes, at block 202, detecting the one or more reference paths corresponding to each resource type by scanning all registered resource schemas using reflection techniques. In such embodiments, the method 200 includes auto-discovering reference and selector fields present in all registered Kubernetes native and custom resource types by parsing their binary schemas using type reflection.

In some other embodiments, for example, when binary schemas are not registered with the runtime client, the method 200 includes, at block 202, detecting the one or more reference paths corresponding to each resource type by scanning text schemas for one or more resource types in the container deployment environment. Non-limiting examples of text schemas include open API schemas, postman schemas, JSON API schemas, and the like. In such embodiments, the method 200 includes using reference signatures for the identification of references during a scan of the reference schemas. The reference signatures may be added to the configuration manually.

The method 200 further includes, at block 202, augmenting auto-detection of the one or more references paths corresponding to a resource type based on manual updates. In such embodiments, the method 200 includes capturing through auto-discovery previously unseen reference types. Further, the method 200 includes specifying the expected types of resources that a given reference field can reference

At block 204, the method 200 includes assigning a resource class to each resource type of the plurality of resources. The resource class includes a core class, a system class, a shared class, or a private class. In some embodiments, method 200 includes, at block 204, assigning a resource class based on class-based rules. The details of class-based rules are described herein earlier.

Further, the method 200 includes, at block 206, grouping the plurality of resources into one or more resource groups for each namespace, based on the corresponding resource type, resource class, and one or more reference paths. The method 200 includes grouping each resource of the plurality of resources into one or more resource groups based on class-based rules. The details of class-based rules are described herein earlier. The method 200 may further include deleting one or more resources of the plurality of resources if there is no group assigned to the one or more resources

The method further includes, at block 208, generating an application group definition based on the one or more resource groups. The application group definition may be used to recreate an application based on the one or more resource groups. The application recreation may include use cases such as application discovery, application backup, application restore, disaster recovery, compliance management, granular recreation, and the like. In some embodiments, the method 200 further includes updating the definition of application groups in Kubernetes clusters periodically.

As noted earlier, an application-aware Kubernetes protection solution has to typically rely on the application owners to provide application group definitions specifying the application boundaries within their respective namespaces. This presents a problem at the start where applications cannot be protected, without the application group definitions in place, and would be delayed until the application owners define them.

Embodiments of the present description address the noted shortcomings in the art by creating resource groups within each namespace. The resources within each namespace are partitioned into resource groups based on their resource types and reference paths such that each resource group is closed with respect to its references and can be independently recreated. One or multiple of these resource groups can later be identified as an application group and can serve as input for application group definitions in a namespace for recreation (e.g., backup and recovery) independent of other resource groups and their resources.

Thus, embodiments of the present description allow for bootstrapping the definition of application groups in clusters post installation of the Kubernetes protection solution as well updating the definition of application groups in Kubernetes clusters periodically. Further, embodiments of the present description allow the application owners to easily identify related groups based on the initial set of identified resource groups and form complete application group definitions for application recreation.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

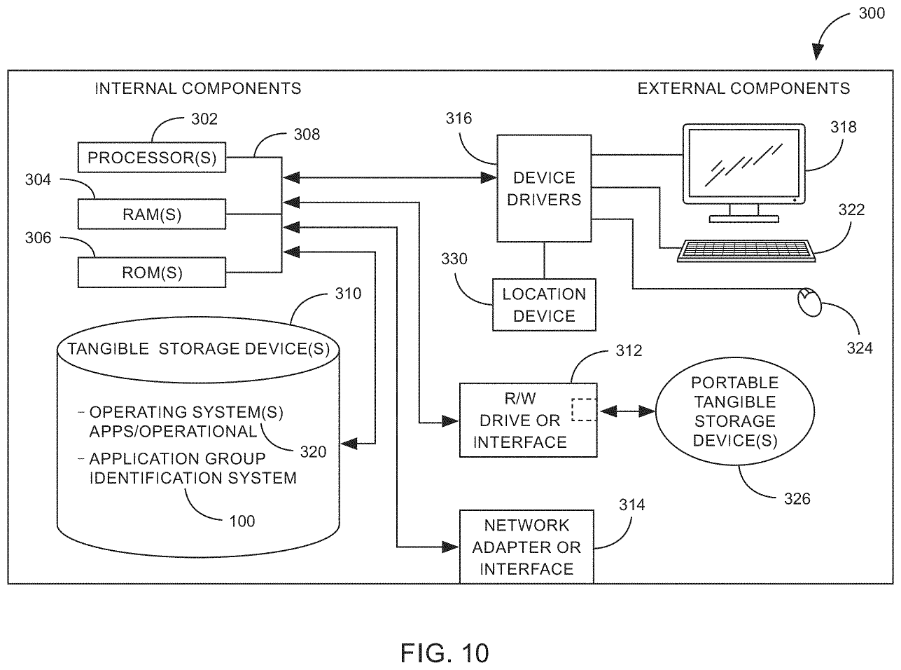

One example of a computing system 300 is described below in FIG. 10. The computing system 300 includes one or more processor 302, one or more computer-readable RAMs 304 and one or more computer-readable ROMs 306 on one or more buses 308. Further, the computer system 308 includes a tangible storage device 310 that may be used to execute operating systems 320 and the application identification system 100. Both, the operating system 320 and application identification system 100 are executed by processor 302 via one or more respective RAMs 304 (which typically includes cache memory). The execution of the operating system 320 and/or the application group identification system 100 by the processor 302, configures the processor 302 as a special-purpose processor configured to carry out the functionalities of the operating system 320 and/or the application group identification system 100, as described above.

Examples of storage devices 310 include semiconductor storage devices such as ROM 506, EPROM, flash memory or any other computer-readable tangible storage device that may store a computer program and digital information.

Computer system 300 also includes a R/W drive or interface 312 to read from and write to one or more portable computer-readable tangible storage devices 326 such as a CD-ROM, DVD, memory stick or semiconductor storage device. Further, network adapters or interfaces 314 such as a TCP/IP adapter cards, wireless Wi-Fi interface cards, or 3G or 4G wireless interface cards or other wired or wireless communication links are also included in the computer system 300.

In one example embodiment, the application identification system 100 may be stored in tangible storage device 310 and may be downloaded from an external computer via a network (for example, the Internet, a local area network or another wide area network) and network adapter or interface 314.

Computer system 300 further includes device drivers 316 to interface with input and output devices. The input and output devices may include a computer display monitor 318, a keyboard 322, a keypad, a touch screen, a computer mouse 324, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for automatically identifying an application group in a container deployment environment, the system comprising:
a reference detection module configured to detect and store one or more reference paths corresponding to each resource type of a plurality of resources in the container deployment environment;
a resource classification module configured to assign a Resource class to each resource type of the plurality of resources;
a resource grouping module configured to group the plurality of resources into one or more resource groups, for each namespace, based on the corresponding resource type, resource class, and one or more reference paths; and
an application group definition module configured to generate an application group definition based on one or more resource groups.

2. The system of claim 1, wherein the resource grouping module is configured to group one or more resources of the plurality of resources into one or more resource groups based on class-based rules.

3. The system of claim 1, wherein the resource class comprises a core class, a system class, a shared class, or a private class.

4. The system of claim 1, further comprising a clean-up module configured to delete one or more resources of the plurality of resources if there is no group assigned to the one or more resources by the resource grouping module.

5. The system of claim 1, wherein the reference detection module is configured to automatically detect the one or more reference paths corresponding to each resource type at start-up or when a new resource definition is identified by scanning binary schemas or text schemas for one or more resource types in the container deployment environment.

6. The system of claim 5, wherein the reference detection module is further configured to augment auto-detection of the one or more reference paths corresponding to a resource type based on manual updates.

7. The system of claim 1, wherein the container deployment environment is a Kubernetes environment.

8. A system for automatically identifying an application group in a container deployment environment, the system comprising:
a memory storing one or more processor-executable routines; and
a processor communicatively coupled to the memory, the processor configured to execute the one or more processor-executable routines to:
detect and store one or more reference paths corresponding to each resource type of a plurality of resources in the container deployment environment;
assign a resource class to each resource type of the plurality of resources;
group the plurality of resources into one or more resource groups for each namespace, based on the corresponding resource type, resource class, and one or more reference paths; and
generate an application group definition based on the one or more resource groups.

9. The system of claim 8, wherein the processor is configured to execute the one or more processor-executable routines to group the plurality of resources into one or more resource groups based on class-based rules, wherein the Resource class comprises a core class, a system class, a shared class, or a private class.

10. The system of claim 8, wherein the processor is further configured to execute the one or more processor-executable routines to delete one or more resources of the plurality of resources if there is no group assigned to the one or more resources.

11. The system of claim 8, wherein the processor is configured to execute the one or more processor-executable routines to automatically detect the one or more reference paths corresponding to each resource type at start-up or when a new resource definition is identified by scanning binary schemas or text schemas for one or more resource types in the container deployment environment.

12. The system of claim 11, wherein the processor is configured to execute the one or more processor-executable routines to augment auto-detection of the one or more references corresponding to a resource based on manual updates.

13. The system of claim 8, wherein the container deployment environment is a Kubernetes environment.

14. A method for automatically identifying an application group in a container deployment environment, the method comprising:
detecting and storing one or more reference paths corresponding to each resource type of a plurality of resources in the container deployment environment;
assigning a resource class to each resource type of the plurality of resources;
grouping the plurality of resources into one or more resource groups for each namespace, based on the corresponding resource type, resource class, and one or more reference paths; and
generating an application group definition based on one or more resource groups.

15. The method of claim 14, wherein the method comprises grouping each resource of the plurality of one or more resource groups based on class-based rules.

16. The method of claim 14, wherein the resource class comprises a core class, a system class, a shared class, or a private class.

17. The method of claim 14, further comprising deleting one or more resources of the plurality of resources if there is no group assigned to the one or more resources.

18. The method of claim 14, wherein the method comprises automatically detecting the one or more reference paths corresponding to each resource type at start-up or when a new resource definition is identified by scanning binary schemas or text schemas for one or more resource types in the container deployment environment.

19. The method of claim 18, wherein the method further comprises augmenting auto-detection of the one or more references corresponding to a resource type based on manual updates.

20. The method of claim 14, wherein the container deployment environment is a Kubernetes environment.
